(19) United States
(12) Patent Application Publication
(10) Pub. No.: US 2024/0428564 A1
(43) Pub. Date: Dec. 26, 2024

(54) DIGITAL IMAGE REPOSING TECHNIQUES

(71) Applicant: Adobe Inc., San Jose, CA (US)

(72) Inventors: Rishabh Jain, Gurgaon (IN); Mayur Hemani, Noida (IN); Mausoom Sarkar, Noida (IN); Krishna Kumar Singh, San Jose, CA (US); Jingwan Lu, Sunnyvale, CA (US); Duygu Ceylan Aksit, London (GB); Balaji Krishnamurthy, Noida (IN)

(73) Assignee: Adobe Inc., San Jose, CA (US)

(21) Appl. No.: 18/213,118

(22) Filed: Jun. 22, 2023

(51) Int. Cl. G06V 10/77; G06T 3/00; G06T 3/40

(52) U.S. Cl. CPC G06V 10/7715; G06T 3/18; G06T 3/40

(57) ABSTRACT

In implementations of systems for generating images for human reposing, a computing device implements a reposing system to receive input data describing an input digital image depicting a person in a first pose, a first plurality of keypoints representing the first pose, and a second plurality of keypoints representing a second pose. The reposing system generates a mapping by processing the input data using a first machine learning model. The mapping indicates a plurality of first portions of the person in the second pose that are visible in the input digital image and a plurality of second portions of the person in the second pose that are invisible in the input digital image. The reposing system generates an output digital image depicting the person in the second pose by processing the mapping, the first plurality of keypoints, and the second plurality of keypoints using a second machine learning model.

### BACKGROUND

Reposing is a technique used in digital images to capture an object from different viewpoints, in different configurations, and so on. Reposing of a human model wearing an item of clothing, for instance, is typically utilized to increase a viewer's understanding of the item of clothing as worn by the human model from different angles, different positions of extremities of the human model's body, and so forth. Conventional techniques to do so, however, encounter numerous technical challenges that result in visual artifacts and inefficient use of computational resources used to implement these conventional techniques.

### SUMMARY

Reposing techniques and systems for generating digital images are described. In an example, a computing device implements a reposing system to receive input data describing an input digital image depicting a person in a first pose, keypoints for the first pose, and keypoints for a second pose. The reposing system generates a mapping, a first predicted image, and a second predicted image by processing the input data using a first machine learning model trained on training data to generate mappings, first predicted images, and second predicted images.

For example, the mapping indicates portions of the person in the second pose that are visible in the input digital image and portions of the person in the second pose that are invisible (e.g., are not visible) in the input digital image. In this example, the first predicted image is generated based on the portions of the person in the second pose that are visible in the input digital image, and the second predicted image is generated based on the portions of the person in the second pose that are invisible in the input digital image. The reposing system generates an output digital image depicting the person in the second pose by processing the mapping, the first predicted image, and the second predicted image using a second machine learning model trained on additional training data to generate output digital images.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures Entities represented in the figures are indicative of one or more entities and thus reference is made interchangeably to single or plural forms of the entities in the discussion.

FIG. 1 is an illustration of an environment in an example implementation that is operable to employ digital systems and techniques for generating images for human reposing as described herein.

FIG. 2 depicts a system in an example implementation showing operation of a reposing module for generating images for human reposing.

FIG. 3 illustrates a representation of a visibility module.

FIG. 4 illustrates a representation of a generator module.

FIG. 5 illustrate a representation of a first machine learning model and a second machine learning model.

FIGS. 6A and 6B illustrate a representation of training machine learning models.

FIG. 7 is a flow diagram depicting a procedure in an example implementation in which an output digital image is generated based on a mapping.

FIG. 8 is a flow diagram depicting a procedure in an example implementation in which an output digital image is generated based on a first predicted image and a second predicted image.

FIG. 9 illustrates an example system that includes an example computing device that is representative of one or more computing systems and/or devices for implementing the various techniques described herein.

### DETAILED DESCRIPTION

### Overview

Human reposing is a generative machine learning task in which a machine learning model receives an input image depicting a person in a first pose and information relating the first pose to a second pose, and the machine learning model generates an output image depicting the person in the second pose. Conventional systems for human reposing often generate the output image as including unrealistic artifacts and distortions for reposing tasks in which the first and second poses vary significantly. The reason that the output image appears unrealistic is due to an inability of conventional systems to determine which pixels of the output image should be reproduced directly from the input image and which pixels of the output image should be predicted from context of the input image. For instance, the artifacts and distortions are a result of predicted output pixels that should have been reproduced and reproduced output pixels which should have been predicted based on the context.

In order to overcome these limitations, techniques and systems for generating images for human reposing are described. In an example, a computing device implements a reposing system to receive input data describing a digital image depicting a person in a first pose, keypoints for the first pose, and keypoints for a second pose. The reposing system generates an output digital image that realistically depicts the person in the second pose based on portions of the person in the second pose that are visible in the input digital image and portions of the person in second pose that are invisible (e.g., are not visible) in the input digital image.

To do so in one example, the reposing system processes the input data using a first machine learning model trained on training data to generate mappings, first predicted images, and second predicted images. The reposing system generates a mapping, first per-pixel displacement flow-field pyramids, and second per-pixel displacement flow-field pyramids by processing the input data using the first machine learning model. The mapping indicates the portions of the person in the second pose that are visible in the input digital image and the portions of the person in second pose that are invisible in the input digital image.

The first machine learning model predicts the first flow-field pyramids at different resolutions for the portions of the person in the second pose that are visible in the input digital image. Similarly, the first machine learning model predicts the second flow-field pyramids at different resolutions for the portions of the person in second pose that are invisible in the input digital image. In one example, the first flow-field pyramids are combined using gated aggregation and then upsampled using convex upsampling to generate a first predicted image for the portions of the person in the second pose that are visible in the input digital image. In another example, the second flow-field pyramids are combined using gated aggregation and then upsampled using convex upsampling to generate a second predicted image for the portions of the person in the second pose that are invisible in the input digital image.

The reposing system processes an output from the first machine learning model, the keypoints for the first pose, and the keypoints for the second pose using a second machine learning model trained on training data to generate output digital images. For example, the second machine learning model includes a pose encoder, a texture encoder, and a decoder. The reposing system processes the keypoints for the first pose and the keypoints for the second pose using the pose encoder to generate pose encodings. In an example, the reposing system processes the mapping, the first predicted image, and the second predicted image using the texture encoder to generate texture encodings at different hierarchical scales.

For example, the reposing system processes the pose encodings as an input to the decoder of the second machine learning model, and the decoder upsamples the pose encodings. Texture is injected into the upsampled pose encodings at different scales using two-dimensional style modulation based on the texture encodings. Images are then predicted at multiple resolutions such that sequentially lower resolution images are added to next higher resolution images after upsampling to generate the output digital image that realistically depicts the person in the second pose.

In an example, the realistic depiction of the person in the output digital image is a result of training the first and second machine learning models end-to-end using a patch-wise self-supervised adversarial loss. For example, by training the first and second machine learning models in this way and by leveraging the portions of the person in the second pose that are visible in the input digital image as well as the portions of the person in the second pose that are invisible in the input digital image, the reposing system reproduces output pixels that should be reproduced from the input digital image and predicts output pixels that should be predicted from context of the input image. As a result, the described systems for generating images for human reposing achieve state-of-the-art in terms of image quality for the task of human reposing. This superior performance is demonstrated relative to conventional systems for human reposing in terms of structural similarity index, learned perceptual image patch similarity, and Fréchet inception distance.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

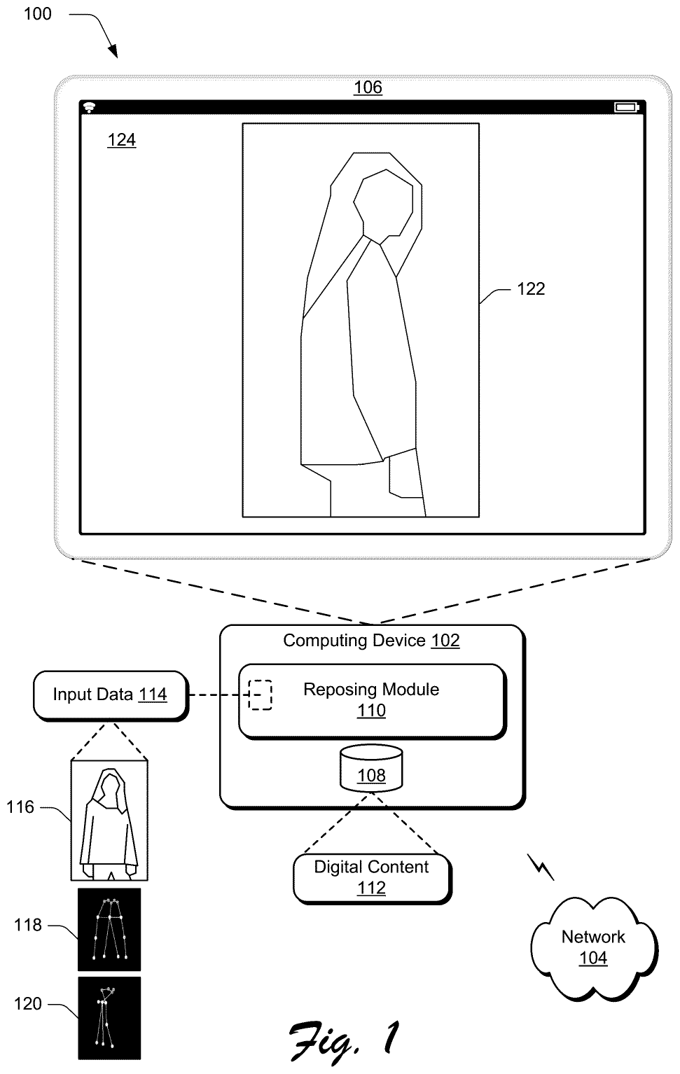

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. For instance, the computing device 102 includes a storage device 108 and a reposing module 110. The storage device 108 is illustrated to include digital content 112 such as digital images, digital artwork, digital videos, etc.

The reposing module 110 is illustrated as having, receiving, and/or transmitting input data 114. In an example, the input data 114 describes an input digital image 116 that depicts a person in a first pose, keypoints 118 for the first pose, and keypoints 120 for a second pose. In this example, the person depicted in the input digital image 116 is wearing dark colored pants and a light colored blouse, and the person is facing forward in the first pose such that the person's face and chest are visible, but the person's back is not visible (e.g., the person's backside is invisible) in the input digital image 116.

The forward facing orientation of the person depicted in the input digital image 116 is represented by the keypoints 118 for the first pose which are generally symmetric in a frontal or coronal plane. However, the keypoints 120 for the second pose are generally asymmetric in the frontal or coronal plane. Because of this asymmetry, generating an image depicting the person in the second pose is not performable without inferring a visual appearance of portions of the person which are not depicted in the input digital image 116. For example, the person's back is partially visible in the second pose, but the person's back is not visible in the input digital image 116. In order to generate an image of the person depicted in the input digital image 116 in the second pose represented by the keypoints 120, the reposing module 110 leverages first and second machine learning models which are included in or are accessible to the reposing module 110.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

Consider an example in which the first machine learning model includes a convolutional neural network and the reposing module 110 processes the input data 114 using the first machine learning module to generate a mapping that indicates portions of the person in the second pose which are visible in the input digital image 116 and portions of the person in the second pose which are invisible in the input digital image 116. In this example, the reposing module 110 also generates a first predicted image and a second predicted image using the first machine learning model based on processing the input data 114. The reposing module 110 generates the first predicted image for the portions of the person in the second pose that are visible in the input digital image 116 and the reposing module 110 generates the second predicted image for the portions of the person in the second pose that are invisible in the input digital image 116.

For example, the reposing module 110 generates the first and second predicted images by generating first and second flow-field pyramids for the portions of the person in the second pose that are visible and invisible in the input digital image 116, respectively. The reposing module 110 generates the first predicted image by using the first flow-field pyramids to warp the input digital image 116 to align with the second pose. Similarly, the reposing module 110 generates the second predicted image by using the second flow-field pyramids to warp the input digital image 116 to align with the second pose.

To do so in one example, the reposing module 110 generates both of the first and second flow-field pyramids at multiple different resolutions or scales. By generating the first and second flow-field pyramids in this way, the first machine learning model is capable of processing and refining the multiple different resolutions or scales sequentially to generate composite flows. The reposing module 110 combines the first flow-field pyramids using gated aggregation to generate a first composite flow for the portions of the person in the second pose that are visible in the input digital image 116. For instance, the reposing module 110 also combines the second flow-field pyramids using gated aggregation to generate a second composite flow for the portions of the person in the second pose that are invisible in the input digital image 116.

The reposing module 110 generates the first predicted image by performing convex upsampling on the first composite flow and generates the second predicted image by performing convex upsampling on the second composite flow. For example, the reposing module 110 implements the second machine learning model to process the first predicted image, the second predicted image, and the mapping that indicates the portions of the person in the second pose which are visible in the input digital image 116 and the portions of the person in the second pose which are invisible in the input digital image 116. In this example, the second machine learning model processes the first and second predicted images and the mapping using a first encoder and the second machine learning model processes the keypoints 118 for the first pose and the keypoints 120 for the second pose using a second encoder.

The reposing module 110 generates pose encodings using the first encoder and texture encodings using the second encoder. In an example, the reposing module 110 processes the pose encodings and the texture encodings using a decoder of the second machine learning model to generate an output digital image 122 which is displayed in a user interface 124 of the display device 106. As shown, the output digital image 122 depicts the person in the second pose such that the person's back is partially visible and the person's right side and right arm are fully visible. For instance, the output digital image 122 realistically depicts the person's back even though the person's backside is invisible in the input digital image 116. This is an improvement relative to conventional systems for human reposing which are limited to generating output images including artifacts and/or discontinuities in generated regions of a particular person that are not depicted in an input image of the particular person.

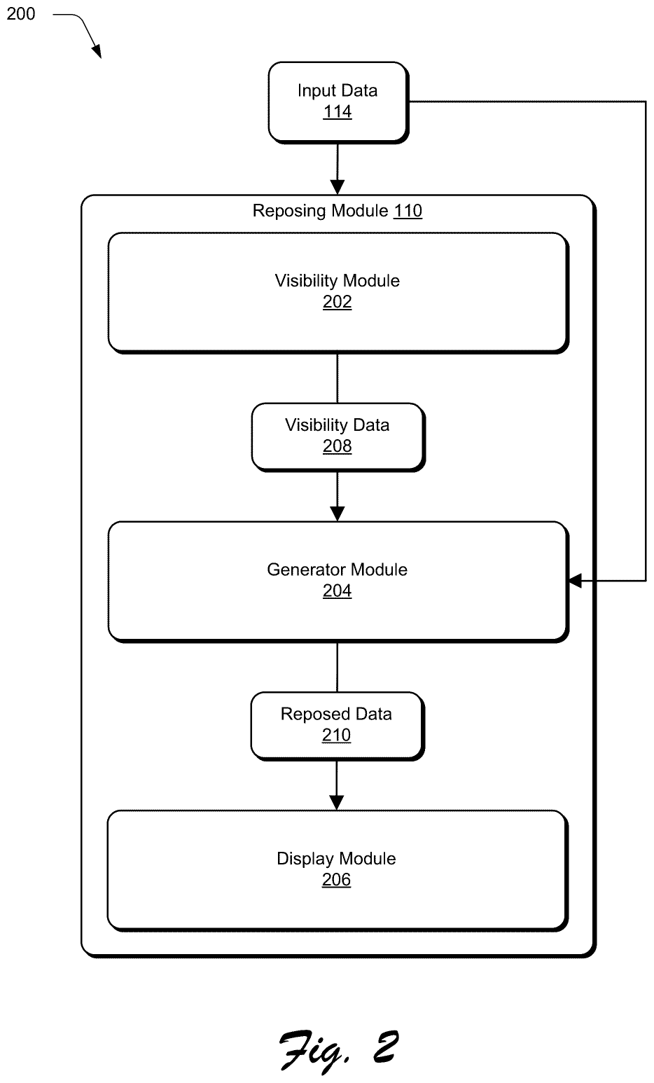

FIG. 2 depicts a system 200 in an example implementation showing operation of a reposing module 110. The reposing module 110 is illustrated to include a visibility module 202, a generator module 204, and a display module 206. For example, the reposing module 110 receives the input data 114 describing the input digital image 116 that depicts the person in a first pose, the keypoints 118 for the first pose, and the keypoints 120 for the second pose. As shown in FIG. 2, the visibility module 202 processes the input data 114 to generate visibility data 208.

FIG. 3 illustrates a representation 300 of a visibility module 202. The representation 300 illustrates the first machine learning model which is included in or available to the visibility module 202. For example, the representation 300 also includes the input digital image 116, the keypoints 118 for the first pose, the keypoints 120 for the second pose, and a target digital image 302. In this example, the target digital image 302 depicts the person in the second pose which the visibility module 202 uses as training data for training the first machine learning model.

As shown, the first machine learning model includes a convolutional neural network 304. For example, the first machine learning model includes the convolutional neural network 304 as described by Olaf Ronneberger et al., U-net: Convolutional Networks for Biomedical Image Segmentation, arXiv: 1505.04597v1 (2015). In an example, the visibility module 202 implements the convolutional neural network 304 to process the input data 114 in order to generate a mapping 306 that indicates portions of the person in the second pose that are visible in the input digital image 116 and portions of the person in the second pose that are invisible in the input digital image 116.

Consider an example in which the visibility module 202 generates a ground truth mapping 308 based on the input digital image 116 and the target digital image 302. In some examples, the visibility module 202 determines UV coordinates using techniques described by Rιza Alp Güler et al., Densepose: Dense Human Pose Estimation in the Wild, In Proceedings of the IEEE Conference on Computer Vision and Pattern Recognition, pages 7297-7306 (2018). In these examples, the visibility module 202 matches the UV coordinates to generate a ground truth visible mask and a ground truth invisible mask which are depicted in the ground truth mapping 308. For example, the visibility module 202 compares the mapping 306 with the ground truth mapping 308 using a categorical cross entropy loss (L_{cce}) as part of training the first machine learning model to generate mappings that indicate portions of people in poses that are visible in input images and portions of the people in the poses that are invisible in the input images.

The visibility module 202 implements the convolutional neural network 304 to generate visible features 310 and invisible features 312. In an example, the convolutional neural network 304 processes the input data 114 to generate the visible features 310 by generating per-pixel flow-field pyramids fᵥ^{l} at different resolutions l. In a similar example, the convolutional neural network 304 processes the input data 114 to generate the invisible features 312 by generating per-pixel flow-field pyramids fᵢ^{l} at different resolutions l.

The visibility module 202 uses the flow-field pyramids fᵥ^{l} and fᵢ^{l} to warp the input digital image 116 to align with the second pose of the person as depicted in the target digital image 302 in order to generate visible regions Iᵥ^{l} 314 and invisible regions Iᵢ^{l} 316. For instance, the visible regions Iᵥ^{l} 314 correspond to the portions of the person in the second pose that are visible in the input digital image 116 and the invisible regions Iᵢ^{l} 316 correspond to the portions of the person in the second pose that are invisible in the input digital image 116. The visibility module 202 leverages both of the flow-field pyramids fᵥ^{l} and fᵢ^{l} based on an observation that predictions for both the visible regions Iᵥ^{l} 314 and the invisible regions Iᵢ^{l} 316 could utilize pixels from a same location in the input digital image 116.

In order to generate the visible regions Iᵥ^{l} 314 and the invisible regions Iᵢ^{l} 316, the visibility module 202 combines the flow-field pyramids fᵥ^{l} using gated aggregation as part of generating the visible features 310 and the visibility module 202 combines the flow-field pyramids fᵢ^{l} using gated aggregation as part of generating the invisible features 312. In an example, the visibility module 202 combines the flow-field pyramids fᵥ^{l} and combines the flow-field pyramids fᵢ^{l} using gated aggregation techniques as described by Ayush Chopra et al., Zflow: Gated appearance flow-based virtual try-on with 3d priors, In Proceedings of the IEEE/CVF International Conference on Computer Vision, pages 5433-5442 (2021), such that flow values are filtered from different radial neighborhoods to generate a composite flow in the visible features 310 and a composite flow in the invisible features 312.

For example, the visibility module 202 constructs a final flow at a 256×256 level for the visible regions Iᵥ^{l} 314 and the invisible regions Iᵢ^{l} 316 by upsampling flows from previous layers using convex upsampling. Convex upsampling is a generalization of bilinear upsampling in which upsampling weights are learnable and conditioned on a neighborhood. This aids in preservation of fine-grained details and sharpens a warped output. Moreover, in some examples, the visibility module 202 utilizes a single decoder to generate both of the flow-field pyramids fᵥ^{l} and fᵢ^{l} which preserves consistency and coherence between visible and invisible warped images. In an example, this is representable as:

fᵥ^{l},fᵢ^{l},VisMap←FP(Iₛ,Kₛ,Kₜ)

fᵥ^{agg},fᵢ^{agg}←GA(fᵥ^{l},fᵢ^{l})

fᵥⁱ,fᵢ^{o}←ConvexUpsample(fᵥ^{agg},fᵢ^{agg})

Iᵥ^{l},Iᵢ^{l}←Warp(Iₛ,fᵥ^{l}),Warp(Iₛ,fᵢ^{l})

where: Iₛ represents the input digital image 116; Kₛ represents the keypoints 118 for the first pose; and Kₜ represents the keypoints 120 for the second pose.

In order to train the first machine learning model in one example, the visibility module 202 segments the mapping 306 into a visible mapping mᵥ 318 and an invisible mapping mᵢ 320 by comparing per-pixel class. In some examples, the visibility module 202 trains the first machine learning module using different types of losses for the visible regions Iᵥ^{l} 314 and the invisible regions Iᵢ^{l} 316. For the visible regions Iᵥ^{l} 314, the visibility module 202 is capable of determining a correspondence between predicted images 322 and a target image 324. Because of this, the visibility module 202 trains the first machine learning model using an L₁ loss and a perceptual loss L_{vgg} for the visible regions Iᵥ^{l} 314. For instance, these losses minimize texture distortion and loss in detail (L₁).

For the invisible regions Iᵢ^{l} 316, the visibility module 202 is not capable of determining a correspondence between predicted images 326 and a target image 328. However, the visibility module 202 is capable of leveraging a style similarity for human reposing for the invisible regions Iᵢ^{l} 316. To do so in one example, the visibility module 202 trains the first machine learning model using a perceptual loss L_{vgg} and a style loss L_{sty} for the invisible regions Iᵢ^{l}316. For example, these losses capture resemblance for regions on invisible mapping mᵢ 320.

The visibility module 202 also minimizes a tv norm on the flow-field pyramids fᵥ^{l} and fᵢ^{l} to ensure spatial smoothness of flow. In an example, the visibility module 202 computes losses for the entire flow-field pyramids fᵥ^{l} and fᵢ^{l}. For example, when the visibility module 202 compares the mapping 306 with the ground truth mapping 308 using the categorical cross entropy loss (L_{cce}) as part of training the first machine learning model, the visibility module 202 uses a teacher forcing technique for the training in which the ground truth mapping 308 is used with a 50 percent probability for warping losses. In some examples, the losses used for training the first machine learning model are representable as:

$${m}_{v} , {m}_{i} ← VisMap$$

$${L}_{wrp} = {\sum }_{l} {L}_{vis} ( {I}_{v}^{l} , {m}_{v} , {f}_{l} ) + {L}_{invis} ( {I}_{i}^{l} , {m}_{i} , {f}_{l} ) + {L}_{cce} ( VisMap , {VisMap}_{gt} )$$

where: ⊙ indicates per-pixel multiplication,

$${L}_{vis} ( I , m , f ) = {β}_{1} {L}_{vgg} ( I ⊙ m , {I}_{t} ⊙ m ) + {β}_{2} {‖ I ⊙ m , {I}_{t} ⊙ m ‖}_{1} + {β}_{3} {L}_{tv} ( f )$$

$${L}_{invis} ( I , m , f ) = {β}_{1} {L}_{vgg} ( I ⊙ m , {I}_{t} ⊙ m ) + {β}_{4} {L}_{sty} ( I ⊙ m , {I}_{t} ⊙ m ) + {β}_{3} {L}_{tv} ( f )$$

The visibility module 202 generates the visibility data 208 as describing an output from the trained first machine learning model. As shown in FIG. 2, the generator module 204 receives the visibility data 208 and/or the input data 114. FIG. 4 illustrates a representation 400 of a generator module 204. In an example, the second machine learning model is included in or available to the generator module 204. The generator module 204 receives the visibility data 208 as describing the mapping 306, a first predicted image Iᵥ 402, and a second predicted image Iᵢ 404. Notably, the first predicted image Iᵥ 402 and the second predicted image Iᵢ 404 correspond to a final level (e.g., the level at resolution 256×256) for transformed image pyramids of the visible regions Iᵥ^{l} 314 and the invisible regions Iᵢ^{l}, respectively. For example, the generator module 204 receives the input data 114 as describing the keypoints 118 for the first pose and the keypoints 120 for the second pose.

As shown in the representation 400, the second machine learning model includes a pose encoder 406 and a texture encoder 408. In some examples, the pose encoder 406 includes a neural network which is a residual network or ResNet and the texture encoder 408 also includes a neural network which is a residual network or ResNet. Since the second machine learning model generates or hallucinates portions of the person in the second pose that are invisible in the input digital image 116, the generator module 204 processes the keypoints 118 for the first pose and the keypoints 120 for the second pose using the pose encoder 406 to obtain a 16×16 resolution pose feature volume. In one example, this is representable as:

eₚ=PoseEnc(Kₛ,Kₜ)

where: Kₛ represents the keypoints 118 for the first pose; and Kₜ represents the keypoints 120 for the second pose.

By processing the keypoints 118 for the first pose and the keypoints 120 for the second pose using the pose encoder 406 to generate pose encodings ep, the second machine learning model is able to distinguish between portions of the output digital image 122 for which corresponding texture from the input digital image 116 is obtainable and for which a design of a clothing item is to be inpainted. For example, the generator module 204 processes the mapping 306, the first predicted image Iᵥ 402, and the second predicted image Iᵢ 404 using the texture encoder 408 and two-dimensional style modulation 410. In an example, the texture encoder 408 computes texture encodings at different hierarchical scales. In this example, low resolution layers are useful for capturing semantics of clothing items, an identity of the person, and a style of individual garments. High resolution layers are useful for encapsulating fine grained details in the input digital image 116.

Consider an example in which the second machine learning model includes an image decoder 412 for generating the output digital image 122. To generate the output digital image 122, the generator module 204 implements the image decoder 412 to receive the pose encodings eₚ as an input, and the image decoder 412 upsamples the pose encodings eₚ to higher resolutions. Texture is injected into the upsampled pose encodings eₚ at different scales using two-dimensional style modulation 410 as described by Badour Albahar et al., Pose with style: Detail-preserving pose-guided image synthesis with conditional stylegan, ACM Transactions on Graphics, 40(6): 1-11 (2021). After the two-dimensional style modulation 410, features are normalized such that the normalized features have zero mean and unit standard deviation. For example, RGB images are predicted at multiple resolutions and sequentially lower resolution images are added to next higher resolution images after upsampling to generate the output digital image 122.

In an example, the second machine learning model fills in invisible regions (e.g., the second predicted image Iᵢ 404) by generating new content similar to neighborhood pixels at inference, the generator module 204 implements the second machine learning model to perform an auxiliary task of inpainting 20 percent of the training time. For instance, a random mask is applied on the target digital image 302 and provided as an input to the second machine learning model. The second machine learning model is then tasked with outputting the complete target digital image 302. By performing the auxiliary task in this way, the second machine learning model learns to complete missing information of warped images in a visually convincing manner. In one example, this is representable as:

eₜₑₓ^{l}=TexEnc(Iᵥᵢₛ,Iᵢₙᵥᵢₛ,VisMap)

I_{gen}=ResNetDec(eₚ,2DStyleMod(eₜₑₓ^{l}))

where: I_{gen} represents the output digital image 122.

The generator module 204 generates reposed data 210 describing the output digital image 122. The display module 206 receives and processes the reposed data 210 to display the output digital image 122 in a user interface such as the user interface 124 of the display device 106. For example, the reposing module 110 enforces L₁, L_{vgg}, L_{style} losses as well as a L_{LSGAN} loss as described by Xudong Mao et al., Least squares generative adversarial networks, In Proceedings of the IEEE International Conference on Computer Vision, pages 2794-2802 (2017), between I_{gen} (e.g., the output digital image 122) and Iₜ (e.g., the target digital image 302).

In an example, the L₁ loss facilitates preservation of the identity of the person, body pose, and cloth texture with pixel level correspondence. The L_{vgg} and L_{style} losses are useful for conserving high level semantic information of garments present on the person and for bringing I_{gen} (e.g., the output digital image 122) perceptually closer to It (e.g., the target digital image 302). For the L_{LSGAN} loss, the keypoints 120 for the second pose along with I_{gen} (e.g., the output digital image 122) are passed to a discriminator of the second machine learning model for improving pose alignment. For example, an adversarial loss is utilized to assist in removing relatively small artifacts and increasing a sharpness of I_{gen} (e.g., the output digital image 122). In one example, this is representable as:

$${L}_{sup} = {α}_{rec} {‖ {I}_{gen} , {I}_{t} ‖}_{1} + {α}_{per} {L}_{vgg} ( {I}_{gen} , {I}_{t} ) + {α}_{sty} {L}_{sty} ( {I}_{gen} , {I}_{t} ) + {α}_{adv} {L}_{LSGAN} ( {I}_{gen} , {I}_{t} , {K}_{t} )$$

where: α refers to weights for different losses; and Lₛᵤₚ refers to a supervised loss when the inputs and outputs are a same person in a same attire.

In addition to the other losses, the reposing module 110 trains the first machine learning model and the second machine learning model end-to-end using a patch-wise self-supervised loss L_{SelfSup} or L_{SS} as described by Phillip Isola et al., Image-to-image translation with conditional adversarial networks, In the IEEE Conference on Computer Vision and Pattern Recognition, pages 5967-5976 (2017). For instance, although the first and second machine learning models are capable of generating perceptually convincing results without the patch-wise self-supervised loss L_{SelfSup} or L_{SS}, it is possible for bleeding artifacts to occur when performing human reposing for a complicated target pose or occluded body regions. It is also possible for discontinuities between clothing and skin interfaces to occur.

Notably, during training, the first and second poses are for the same person wearing the same apparel which would introduce a bias in the first machine learning model and the second machine learning model which could deteriorate results when, for example, a body shape of a person from which the second pose is extracted varies significantly from a body shape of a person from which the first pose is extracted. Because of this, the reposing module 110 trains the first machine learning model and the second machine learning model end-to-end using the patch-wise self-supervised loss L_{SelfSup} or L_{SS} on a task of identifying if a particular patch is real or not real. Therefore, during fine-tuning, the reposing module 110 chooses unpaired images with a 50 percent probability from a single batch. For example, only an adversarial loss is applied on the unpaired images and Lₛᵤₚ loss is present on the paired images. In an example, this is representable as:

L_{SelfSup}=L_{SS}=L_{PatchGAN}(I_{gen},Iₜ)

In some examples, the Lₛᵤₚ loss, the L_{SelfSup} loss, and a L_{wrp} loss are used to fine-tune the first machine learning model and the second machine learning model in an end-to-end manner. FIG. 6 illustrates a representation 600 of images generated for human reposing. For example, after fine-tuning the first machine learning model and the second machine learning model in the end-to-end manner, the reposing module 110 is capable of implementing the first and second machine learning models to generate output digital images 602 depicting people in second poses based on input digital images 604-620 depicting people in first poses and keypoints for the second poses.

The representation 600 also includes examples of digital images generated for human reposing based on the input digital images 604-620 and the keypoints for the second poses using conventional systems. For instance, input digital image 612 depicts a first person facing backwards such that only the first person's back is visible in the input digital image (e.g., the first person's face is invisible in the input digital image 612). A corresponding one of the output digital images 602 realistically depicts the first person facing forwards including a realistic depiction of the first person's face. In another example, input digital image 618 depicts a second person facing forwards such that only the second person's face and chest are visible in the input digital image 618. As shown in the representation 600, a corresponding one of the output digital images 602 realistically depicts the second person facing backwards. As further shown in the representation 600, corresponding output digital images generated by the conventional systems based on the input digital image 618 and keypoints for the backwards facing second pose do not appear realistic and instead include blurring and other artifacts.

FIG. 5 illustrate a representation 500 of a first machine learning model and a second machine learning model. The representation 500 includes a convolutional neural network 502 and a generative adversarial network 504. For example, the first machine learning model includes the convolutional neural network 502 and the second machine learning model includes the generative adversarial network 504.

In an example, the convolutional neural network 502 includes a gated aggregation network 506. In this example, the gated aggregation network 506 is capable of performing the gated aggregation techniques described above. In another example, the generative adversarial network 504 includes a first residual convolutional neural network 508 and a second residual convolutional neural network 510. In one example, the first residual convolutional neural network 508 and the second residual convolutional neural network 510 are each implemented using a ResNet architecture as described above.

FIGS. 6A and 6B illustrate a representation of training machine learning models. FIG. 6A illustrates a representation 600 of training the first machine learning model, e.g., a convolutional neural network 502 of FIG. 5. FIG. 6B illustrates a representation 602 of training the second machine learning model, e.g., a generative adversarial network 504 of FIG. 5.

As shown in FIG. 6A, training data is collected (at 604). For example, the training data is configurable to include a training set of digital images. The training set of digital images includes annotations that are then used as a basis to train a machine learning model, e.g., using the annotation as labels. The annotations, for instance, include bounding boxes describing a location of an item of interest (e.g., an article of clothing), landmarks identifying points of interest on the article of clothing (e.g., corners, center, ends), type and category of the article of clothing, attribute labels (e.g., presence of attributes such as sleeves, fit), and so forth. An example of which includes a dataset as described by Liu et al., Deepfashion: Powering robust clothes recognition and retrieval with rich annotations, In the IEEE Conference on Computer Vision and Pattern Recognition (CVPR), 5 (June 2016). Relevant features are identified (at 606), e.g., from the annotations. In an example, keypoints are extracted as described above that describe landmarks within a particular article of clothing, human model, and so forth. The first machine learning model is initialized (at 608), e.g., initial values are set such as weights and biases of neurons in a neural network.

A first loss function is selected (at 610). The loss function is used to quantify “how well” predictions made by the machine learning model align with an expectation, e.g., a desired outcome. For example, the first loss function is the L₁ loss, which is also known as a Least Absolute Deviations (LAD) or Mean Absolute Error (MAE) loss is usable to measure absolute differences between a true value and a predicted value. A second loss function is selected (at 612). In an example, the second loss function is the perceptual loss L_{vgg}. Perceptual loss is utilized to address high-level features of images in addition to pixel-level differences. A third loss function is selected (at 614). In some examples, the third loss function is the categorical cross entropy loss L_{cce}. The categorical cross entropy loss is utilized for multi-class classification in which an input may be assigned to one or a plurality of different classes. A fourth loss function is selected (at 616). The fourth loss function is the style loss L_{sty} in one example. Style loss is used to measure a difference in style between two digital images such that an input image and a style reference image are usable to generate a new image that maintains content from the input image and style from the style reference image.

An optimization algorithm is selected (at 618). In an example, the optimization algorithm is an Adam optimization algorithm. The Adam optimization algorithm supports efficient stochastic optimization, e.g., for use in calculating gradients and updating moment estimates.

Hyperparameters are also set (at 620). Hyperparameters, for instance, are set by a user to control a training process, e.g., learning rate, number of layers and neurons, batch size, number of epochs, to specify an activation function, regularization parameters, and so on. For example, a learning rate of 5e−5 is set.

The first machine learning model is then trained using the training data (at 622) until a stopping criterion is met (at 624). The stopping criterion is set based on a rule or heuristic to specify when the training process is to be stopped, e.g., to protect against overfitting. Examples of stopping criteria include a maximum number of epochs, a validation loss, based on learning rate, convergence, and so on. An output is then generated in this example based on the training data using the trained first machine learning model (at 626).

As shown in FIG. 6B, training data is collected (at 628). For instance, the training data is collected to include outputs from the trained first machine learning model (at 626) as previously described in relation to FIG. 6A. The second machine learning model is initialized (at 630) as previously described, e.g., initial values are set such as weights and biases of neurons in a neural network.

A first loss function is selected (at 632). Similar to the above example of FIG. 6A, the first loss function may be set as the Ly loss. A second loss function is selected (at 634), e.g., as a perceptual loss L_{vgg}. A third loss function is selected (at 636), e.g., as a L_{LSGAN} loss. A fourth loss function is also selected (at 638), e.g., as a style loss L_{sty}.

An optimization algorithm is also selected (at 618). In an example, the optimization algorithm is the Adam optimization algorithm as also described above. The Adam optimization algorithm supports efficient stochastic optimization, e.g., for use in calculating gradients and updating moment estimates.

Hyperparameters are set (at 620) as part of training of the second machine learning model. Hyperparameters, for instance, are set by a user to control a training process, e.g., learning rate, number of layers and neurons, batch size, number of epochs, to specify an activation function, regularization parameters, and so on. For example, the learning rate of 5e−5 is set.

The second machine learning model is then trained using the training data (at 640) until a stopping criterion is met (at 642). The stopping criterion is set based on a rule or heuristic to specify when the training process is to be stopped, e.g., to protect against overfitting. Examples of stopping criteria include a maximum number of epochs, a validation loss, based on learning rate, convergence, and so on. An output is then generated based on subsequent data using the trained first machine learning model and the trained second machine learning model (at 644), e.g., to generate an output in “real world” scenarios. In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6. FIG. 7 is a flow diagram depicting a procedure 700 in an example implementation in which an output digital image is generated based on a mapping.

Input data is received describing an input digital image depicting a person in a first pose, a first plurality of keypoints representing the first pose, and a second plurality of keypoints representing a second pose (block 702). For example, the computing device 102 implements the reposing module 110 to receive the input data. A mapping is generated by processing the input data using a first machine learning model, the mapping indicating a plurality of first portions of the person in the second pose that are visible in the input digital image and a plurality of second portions of the person in the second pose that are invisible in the input digital image (block 704). In an example, the reposing module 110 implements the first machine learning model to generate the mapping by processing the input data. An output digital image depicting the person in the second pose is generated by processing the mapping, the first plurality of keypoints representing the first pose, and the second plurality of keypoints representing the second pose using a second machine learning model (block 706). In some examples, the reposing module 110 generates the output digital image.

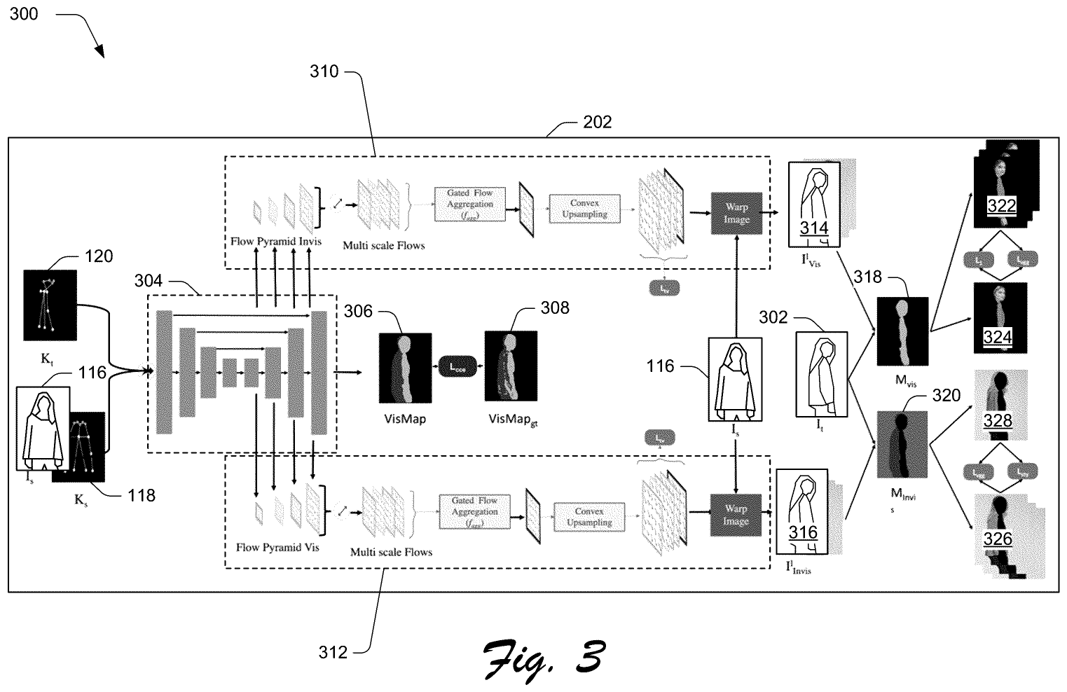

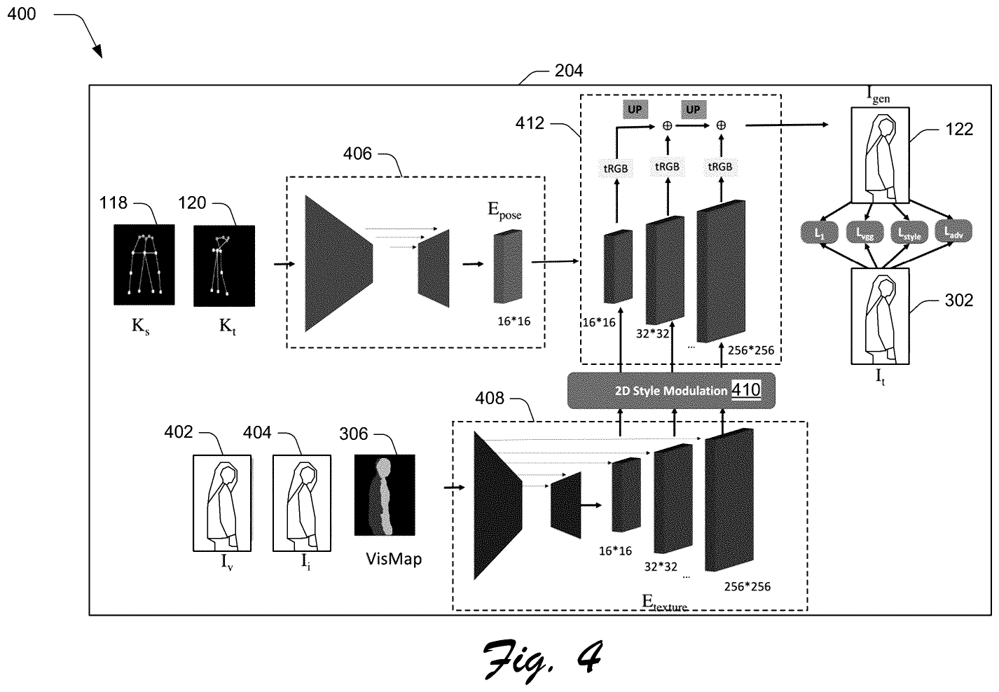

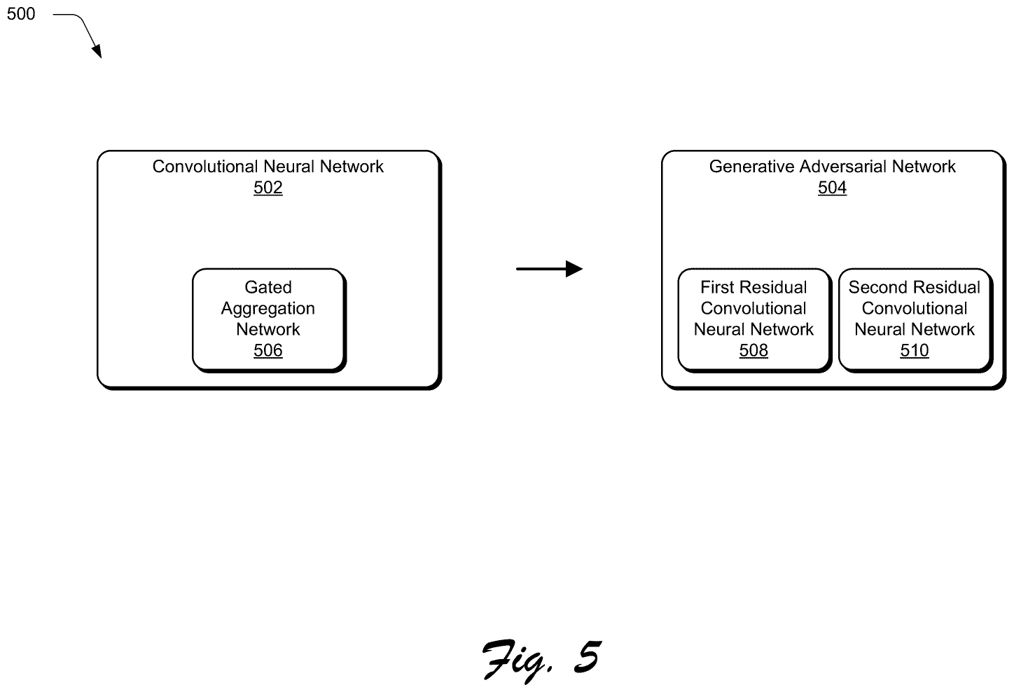

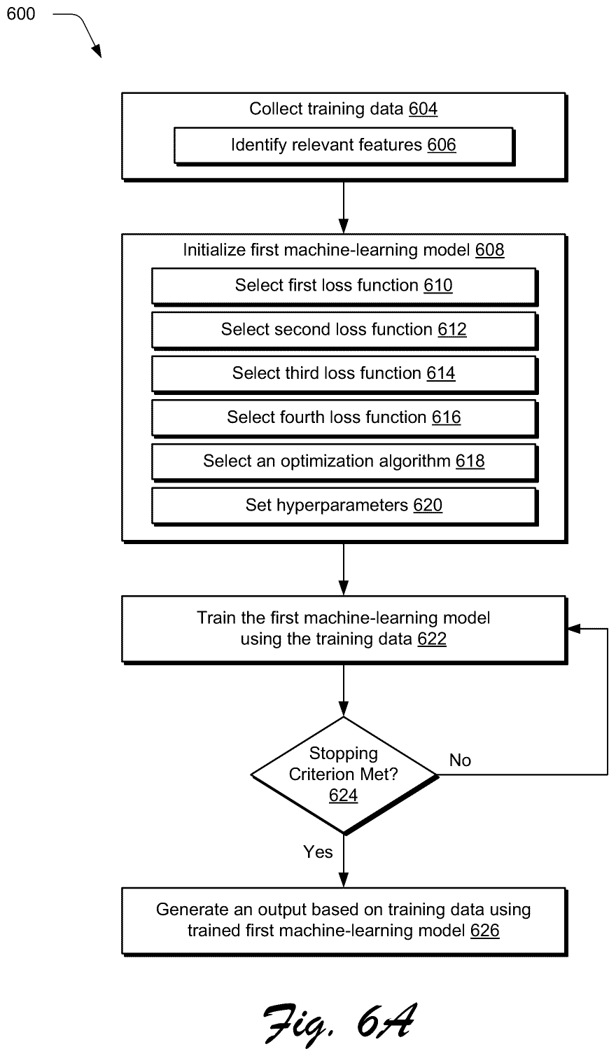

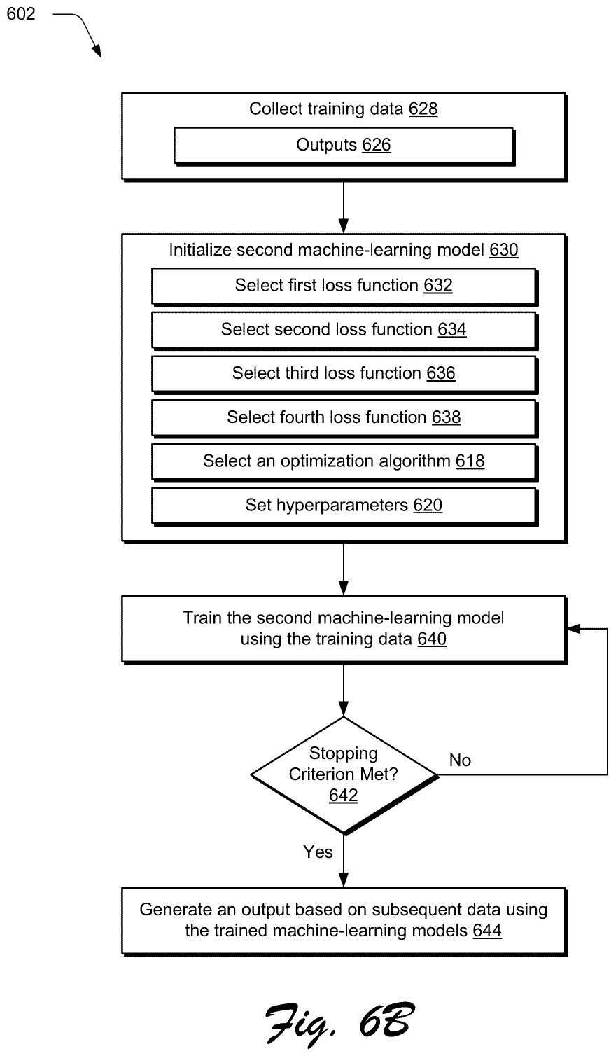

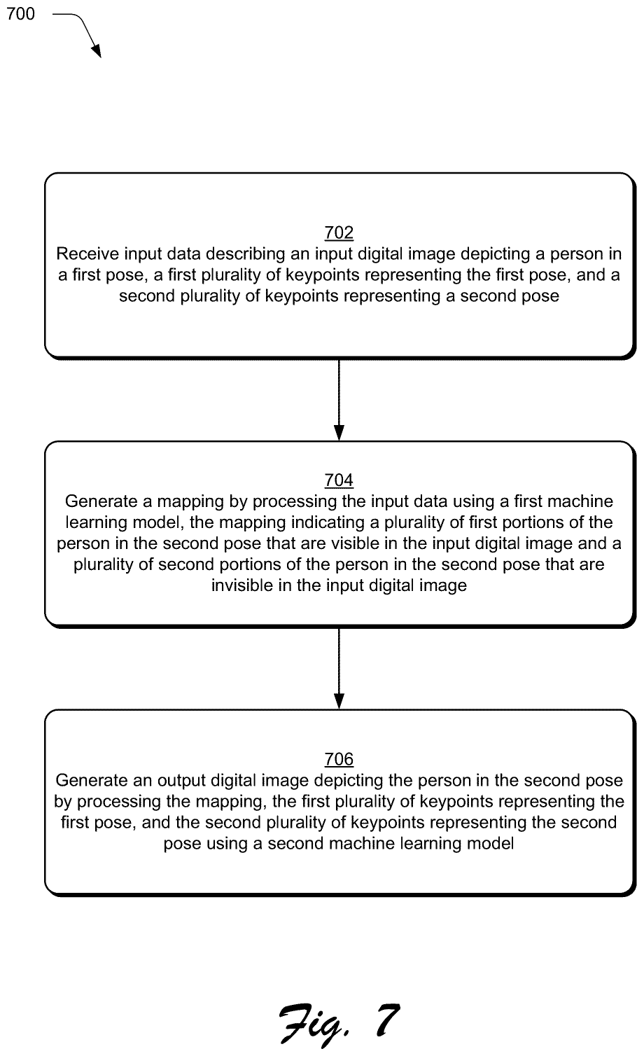

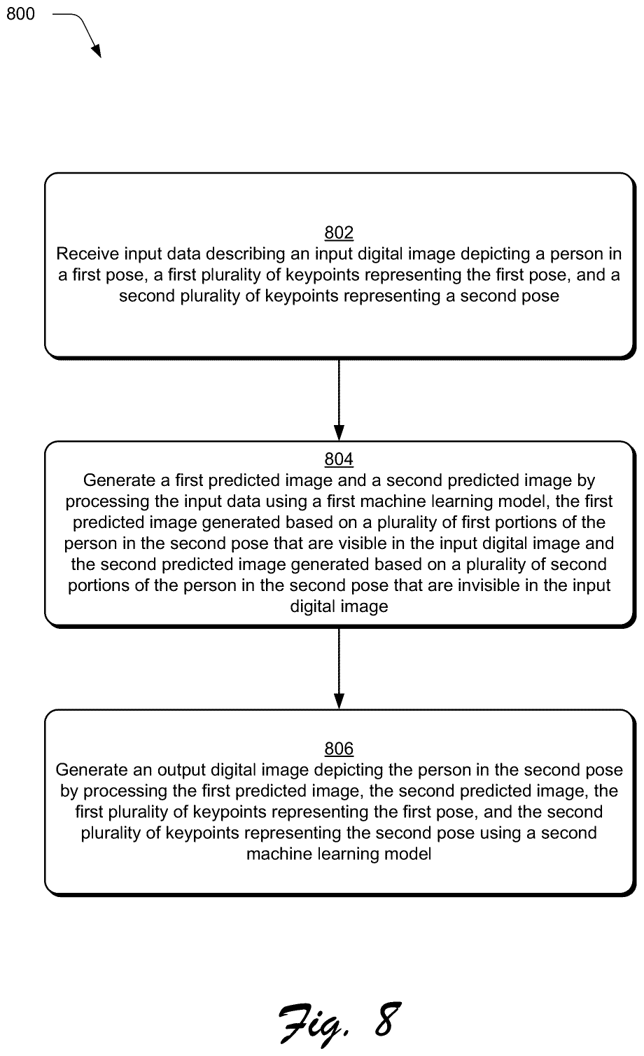

FIG. 8 is a flow diagram depicting a procedure 800 in an example implementation in which an output digital image is generated based on a first predicted image and a second predicted image. Input data is received describing a digital image depicting a person in a first pose, a first plurality of keypoints representing the first pose, and a second plurality of keypoints representing a second pose (block 802). In one example, the computing device 102 implements the reposing module 110 to receive the input data.

A first predicted image and a second predicted image are generated by processing the input data using a first machine learning model, the first predicted image generated based on a plurality of first portions of the person in the second pose that are visible in the input digital image and the second predicted image generated based on a plurality of second portions of the person in the second pose that are invisible in the input digital image (block 804). For example, the reposing module 110 generates the first predicted image and the second predicted image using the first machine learning model. An output digital image depicting the person in the second pose is generated by processing the first predicted image, the second predicted image, the first plurality of keypoints representing the first pose, and the second plurality of keypoints representing the second pose using a second machine learning model (block 806). The reposing module 110 generates the output digital image in an example.

### Example System and Device

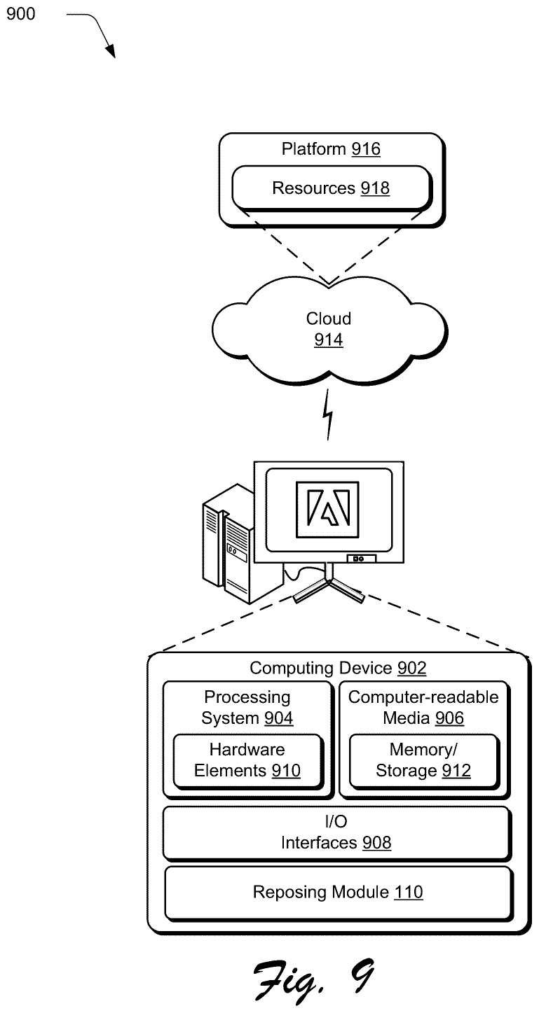

FIG. 9 illustrates an example system 900 that includes an example computing device that is representative of one or more computing systems and/or devices that are usable to implement the various techniques described herein. This is illustrated through inclusion of the reposing module 110. The computing device 902 includes, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that are configured as processors, functional blocks, and so forth. This includes example implementations in hardware as an application specific integrated circuit or other logic device formed using one or more semiconductors. The hardware elements 910 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 906 is illustrated as including memory/storage 912. The memory/storage 912 represents memory/storage capacity associated with one or more computer-readable media. In one example, the memory/storage 912 includes volatile media (such as random access memory (RAM)) and/or nonvolatile media (such as read only memory (ROM), Flash memory, optical disks, magnetic disks, and so forth). In another example, the memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 910. For example, the computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supportable by various configurations of the computing device 902 and are not limited to the specific examples of the techniques described herein. This functionality is also implementable entirely or partially through use of a distributed system, such as over a “cloud” 914 as described below.

The cloud 914 includes and/or is representative of a platform 916 for resources 918. The platform 916 abstracts underlying functionality of hardware (e.g., servers) and software resources of the cloud 914. For example, the resources 918 include applications and/or data that are utilized while computer processing is executed on servers that are remote from the computing device 902. In some examples, the resources 918 also include services provided over the Internet and/or through a subscriber network, such as a cellular or Wi-Fi network.

The platform 916 abstracts the resources 918 and functions to connect the computing device 902 with other computing devices. In some examples, the platform 916 also serves to abstract scaling of resources to provide a corresponding level of scale to encountered demand for the resources that are implemented via the platform. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving, by a processing device, input data describing:
an input digital image depicting a person in a first pose;
a first plurality of keypoints representing the first pose; and
a second plurality of keypoints representing a second pose;
generating, by the processing device, a mapping by processing the input data using a first machine learning model, the mapping indicating a plurality of first portions of the person in the second pose that are visible in the input digital image and a plurality of second portions of the person in the second pose that are invisible in the input digital image; and
generating, by the processing device, an output digital image depicting the person in the second pose by processing the mapping, the first plurality of keypoints representing the first pose, and the second plurality of keypoints representing the second pose using a second machine learning model.

2. The method as described in claim 1, wherein the output digital image is generated based on a first predicted image for the plurality of first portions of the person in the second pose that are visible in the input digital image and a second predicted image for the plurality of second portions of the person in the second pose that are invisible in the input digital image.

3. The method as described in claim 2, wherein the first predicted image and the second predicted image are generated by warping the input digital image using the first machine learning model.

4. The method as described in claim 2, wherein the first predicted image and the second predicted image are generated using convex upsampling.

5. The method as described in claim 1, further comprising generating first flow-field pyramids for the plurality of first portions of the person in the second pose that are visible in the input digital image and second flow-field pyramids for the plurality of second portions of the person in the second pose that are invisible in the input digital image.

6. The method as described in claim 5, wherein the first flow-field pyramids are combined using first gated aggregation and the second flow-field pyramids are combined using second gated aggregation.

7. The method as described in claim 1, wherein the first machine learning model and the second machine learning model are trained end-to-end using a patch-wise self-supervised loss.

8. The method as described in claim 7, wherein the first machine learning model is trained on training data to generate mappings using at least one of a perceptual loss or a style loss.

9. The method as described in claim 7, wherein the second machine learning model is trained on training data to generate output digital images using an adversarial loss.

10. A system comprising:
a memory component; and
a processing device coupled to the memory component, the processing device to perform operations comprising:
receiving input data describing:
an input digital image depicting a person in a first pose;
a first plurality of keypoints representing the first pose; and
a second plurality of keypoints representing a second pose;
generating a first predicted image and a second predicted image by processing the input data using a first machine learning model, the first predicted image generated based on a plurality of first portions of the person in the second pose that are visible in the input digital image and the second predicted image generated based on a plurality of second portions of the person in the second pose that are invisible in the input digital image; and
generating, by the processing device, an output digital image depicting the person in the second pose by processing the first predicted image, the second predicted image, the first plurality of keypoints representing the first pose, and the second plurality of keypoints representing the second pose using a second machine learning model.

11. The system as described in claim 10, wherein the output digital image is generated based on a mapping that indicates the plurality of first portions of the person in the second pose that are visible in the input digital image and the plurality of second portions of the person in the second pose that are invisible in the input digital image.

12. The system as described in claim 10, wherein the first predicted image and the second predicted image are generated using convex upsampling.

13. The system as described in claim 10, wherein the first predicted image and the second predicted image are generated by warping the input digital image using the first machine learning model.

14. The system as described in claim 10, further comprising generating first flow-field pyramids for the plurality of first portions of the person in the second pose that are visible in the input digital image and second flow-field pyramids for the plurality of second portions of the person in the second pose that are invisible in the input digital image.

15. The system as described in claim 14, further comprising combining the first flow-field pyramids using first gated aggregation and combining the second flow-field pyramids using second gated aggregation.

16. A non-transitory computer-readable storage medium storing executable instructions, which when executed by a processing device, cause the processing device to perform operations comprising:
receiving training data describing:
a training digital image depicting a person in a first pose;
a first plurality of training keypoints representing the first pose; and
a second plurality of training keypoints representing a second pose;
generating a training mapping by processing the training data using a first machine learning model trained on the training data to generate mappings, the training mapping indicating a plurality of first portions of the person in the second pose that are visible in the training digital image and a plurality of second portions of the person in the second pose that are invisible in the training digital image; and
training a second machine learning model to generate an output digital image depicting the person in the second pose using the training mapping and a loss function.

17. The non-transitory computer-readable storage medium as described in claim 16, wherein the operations further comprise generating first flow-field pyramids for the plurality of first portions of the person in the second pose that are visible in the training digital image and second flow-field pyramids for the plurality of second portions of the person in the second pose that are invisible in the training digital image.

18. The non-transitory computer-readable storage medium as described in claim 17, wherein the first flow-field pyramids are combined using first gated aggregation and the second flow-field pyramids are combined using second gated aggregation.

19. The non-transitory computer-readable storage medium as described in claim 16, wherein the operations further comprise training the first machine learning model and the second machine learning model end-to-end using a patch-wise self-supervised loss.

20. The non-transitory computer-readable storage medium as described in claim 16, wherein the output digital image is generated based on a first predicted image for the plurality of first portions of the person in the second pose that are visible in the training digital image and a second predicted image for the plurality of second portions of the person in the second pose that are invisible in the training digital image.
